(19) United States
(12) Patent Application Publication
(10) Pub. No.: US 2009/0089039 A1
(43) Pub. Date: Apr. 2, 2009

(54) SYSTEM AND METHOD OF EMULATING FUNCTIONALITY OF A WEB SERVICE

(76) Inventors: Ilan Shufer, Tel Aviv (IL); Iftach Regoler, Givat Brener (IL); Dana Torok, Tel-Aviv (IL); Oren Paikowsky, Haifa (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/865,633

(22) Filed: Oct. 1, 2007

(51) Int. Cl. G06F 9/455

(52) U.S. Cl. 703/23

(57) ABSTRACT

A system and method are provided for emulating the functionality of a web service. The system can include a web server that is configured to host web services. A web service can be configured to execute on the web server as defined by a service definition file. The web service can contain a plurality of executable emulation rules, and the emulation rules can include request argument formats and response formats. An end user can enter values using a graphical user interface for the expected request arguments and response values to be returned by the web service for each executable emulation rule, when the expected request arguments are received.

### BACKGROUND

A Service-Oriented Architecture (SOA) has the characteristics of distributed computing and modular programming. SOAs build applications from many software services or web services. The web services are relatively large, unassociated units of functionality, which generally do not have calls to each other. Web services typically implement functions most people would recognize as a service, such as providing an online application or viewing an online bank statement. Instead of services embedding calls to each other in their source code, protocols are defined which describe how services can send messages to each other.

This service architecture relies on a business process expert to link and sequence services to form an application and this is sometimes called orchestration. In the process of orchestration, software functionalities or web services are associated in a non-hierarchical arrangement by a software developer using a software tool which contains a list of available services and their characteristics. Metadata is used to describe the service characteristics and the data interfaces for the networked web services. XML has been used extensively in SOA to create data which is wrapped in a detailed description container. The services themselves can be described by a WSDL file (Web Services Description Language) and the communications protocols may be described by SOAP (Simple Object Access Protocol).

The goal of SOA is to allow large blocks of functionality to form combined applications which are built largely from existing software services. The larger the service blocks, the fewer interface points are required to implement any defined functionality. However, each interface brings with it some amount of processing overhead, so there are performance considerations.

For software developers who create web service applications implemented and delivered on the Internet, it is often desirable to test the operation of a web service under development before the functionality of other needed web services have been completed. Otherwise, portions of the web service development may reach a standstill while the developers wait for the interdependent services to be completed. While the contract or definitions that govern the communications structure of an incomplete service may have been completed, it is difficult to use the definitions alone for preliminary testing purposes.

### BRIEF DESCRIPTION OF THE DRAWINGS

FIG. 1 is a block diagram illustrating an embodiment of a localized system for emulating functionality of a web service;

FIG. 2 is an illustration of an embodiment of a tree user interface for creating and viewing rules contained in a web service;

FIG. 3 is an illustration of an embodiment of a user interface for creating and editing emulation rules contained in a web service;

FIG. 4 is an illustration of editing an emulation rule contained in a web service as presented by the user interface in an embodiment;

FIG. 5 is an illustration of an embodiment of a user interface for creating and editing a default emulation rule contained in a web service;

FIG. 6 is a block diagram illustrating an embodiment of a networked system for emulating functionality of a web service; and

FIG. 7 is a flow chart illustrating an embodiment of a method of emulating functionality of a web service hosted by a web server.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the embodiments of the inventions as illustrated herein, which would occur to one skilled in the relevant art and having possession of this disclosure, are to be considered within the scope of the invention.

Throughout the following description, reference designators are used to identify elements of the drawings. Like reference designators are used to refer to like elements, while different instances of an element type are referred to by appending a letter suffix to the reference designator (e.g., 14a, 14b, 14c).

A system and method are provided for emulating the functionality of a web service. The emulation of a web service's functions enables testing with web services that are incomplete or not available over a network. The emulated functions of the web service enable tests and designs to be executed in the early stages of web service development.

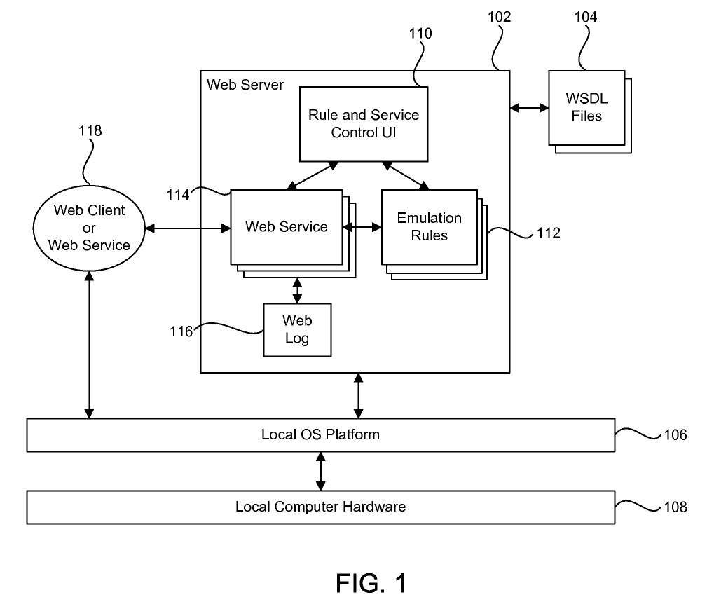

FIG. 1 illustrates that a web server 102 is configured to host web services 114. The web server may be running on top of a local operating system (OS) platform 106 which is executing on local computer hardware 108. The local web server and its services are made available to a web client 118, web service, orchestrated application, or another component that may be tested against the web services on the web server.

A service definition file 104 or WSDL (Web Services Definition Language) file can be provided to define a web service 114, and the service definition file is loadable by the web server 102. When the service definition file or WSDL is loaded by the web server, then the web server can instantiate and deploy the web service on the web application server so that the web service is accessible to other requesting services. The web service and its pre-defined request and response formats (i.e., input arguments and outputs) are generally defined by the service definition file or WSDL. The deployed web service used for emulating functionality can also have a web log 116 and any other of the normal attributes and interfaces that are used by production web services.

A plurality of executable emulation rules 112 can be contained in each web service. These emulation rules can be created by an end user or software developer after the web service has been deployed. The emulation rules include request argument formats and response formats as defined in the service definition file. These request argument formats and response formats are defined in advance by contracts prepared by the software developers. As a result, the emulation rules have an expected and well-defined input and output format for incoming arguments or response data for the web service. The incoming arguments and responses can be sent using HTTP, HTTPS, JMS, FTP and any other similar networking protocols or transports. The term emulation rule refers to the emulation of the high level arguments that pass business rules and data to the web server, but this does not include emulating any information about the complex SOAP or underlying communications data structures. A user interface 110 for entering, editing and deleting rules and otherwise accessing the web services is also illustrated. This user interface will be described in more detail later.

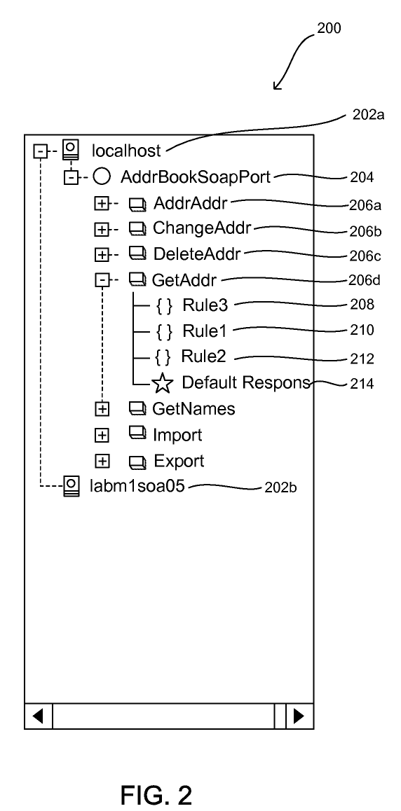

FIG. 2 illustrates a plurality of emulated rules that are executed within the web service. In particular, a graphical user interface 200 is shown with a tree control. The tree control can display the name of the physical servers 202a, 202b where one or more web servers 204 are hosted. Each web server can have one or more web services 206a-d in the web server. Each service may have one or more emulation rules 208-214 created in the web service.

A priority value can be applied to each of the plurality of executable emulation rules, as illustrated in FIG. 2. The rules are illustrated as having a priority 1-3 in the figure. In this situation, the higher priority rules have precedence over lower priority rules in a conflict between the incoming request arguments.

As the web service definitions change and overall communication protocols change, the present system and method can be modified by loading the new web service definitions. An example of this is that any changes to a WSDL or communication protocols can be easily implemented in the emulated rules without significant end user work or additional programming by just reloading the re-defined service. This way the system can quickly use the constantly changing web service toolkits (e.g., .NET, Axis, etc.) without changing the underpinnings of the rule emulation system.

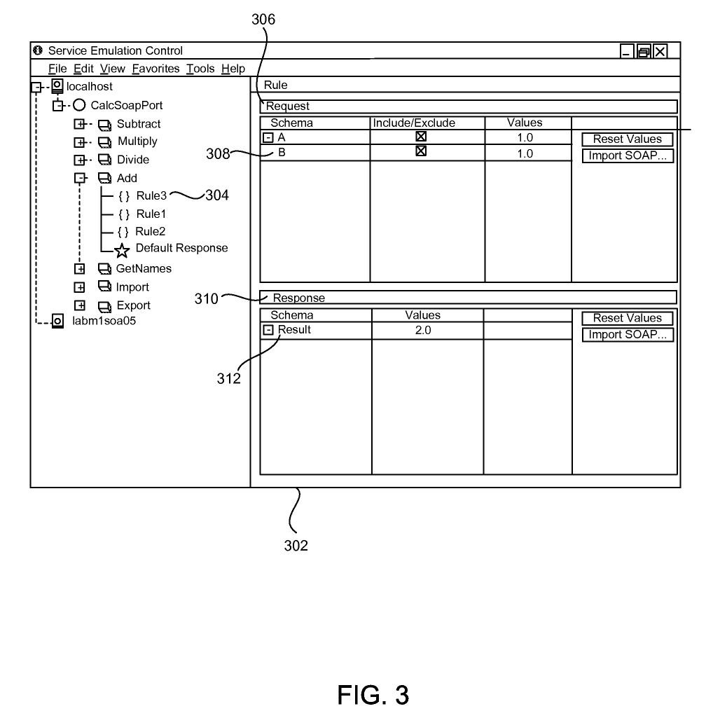

FIG. 3 illustrates that a graphical user interface 302 can be provided to an end user to enable the user to enter values for the emulation rules 304. The user is able to access the rule's expected request arguments 306 and enter the desired values 308 for the request arguments. The graphical controls can also be used to access the response formats 310 and enter the response values 312.

The defined values for the response values can be returned by the web service when the defined request arguments are received from a requesting service, client or another process. In other words, each executable emulation rule will have defined values for request arguments that may be received from a requesting service or client. When the expected request arguments are received from the requesting service, the matching emulation rule will send back the response values that have been set by the user.

The emulation rules can be created with the user interface as shown in FIG. 3 and then the rules may be applied using compiled code callable by the web service for executing the rules. The compiled code for processing the request arguments and response arguments can also be generated when the web service definition or WSDL is loaded.

In one embodiment, the web service is created and can contain logic that makes calls to an independent rules engine. The rules that are designed by the end user can be added to a database (e.g., an XML database). When requests are made to the web service, the web service calls the rule engine which searches through the rules in the database to find the rule that matches the request. Then rule engine returns the appropriate response to the web service which returns the response to the requesting service or client.

In other embodiments, the emulation rules themselves may either be compiled into executable code that is internally useable by the web service, built into tables for executable access, or the emulation rules may be interpreted by an interpreting engine that is built into the specially configured web service. For example, the appropriate interpretation engine may be included and loaded with the WSDL when the WSDL file is loaded and started.

The web service described herein is an actual web service with all the attributes of a web service including logging, communication ports, and common web service functions. The web service is not an emulated web service, but the emulation rules are used to emulate the actual functionality that will be programmed at some later point for the web service.

Using the web services with emulated rules enables more frequent and extensive testing as the applications are being developed. In addition, software tests can be developed in parallel with the development and implementation of the web services. Since a contract is agreed upon for the web services in advance of the service implementation (e.g. WSDLs), testers are able to start developing and implementing functional, load, and regression tests in parallel with the web service development effort. In addition, the present system and method is straight forward to operate and so a tester can easily develop the tests without particular knowledge of any programming language or communications protocol. As a result of this system, testing a service may be completed as soon as the web service development has been completed.

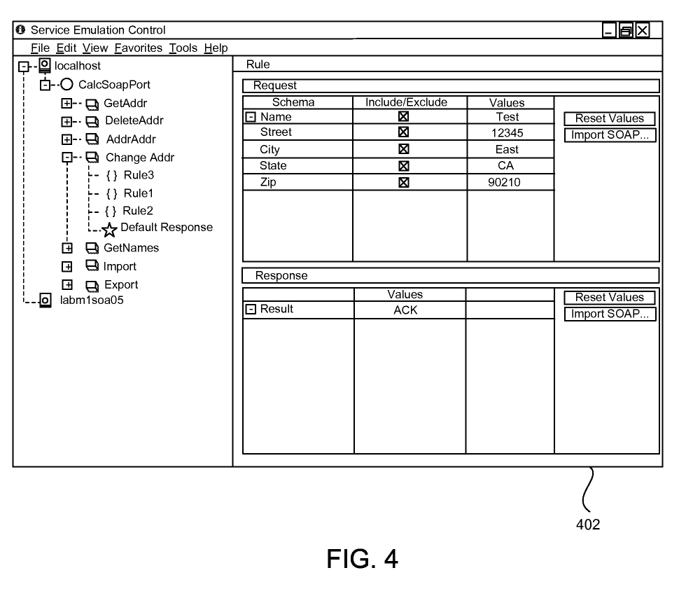

FIG. 4 illustrates the same user interface as in FIG. 3 but the request arguments that are entered by the end user or software developer are more extensive. This is an example of an entire record that is sent to a web service, which may be used by a database when the functioning web service is later completed. As a result, the emulated rule in the web service may send back an acknowledgement stating that the database record was received and has been simulated as being entered into a database.

As discussed previously, when the request arguments are received by the web service, then the web service will check through the rules listing to see which rules have user entered argument values that match the incoming request argument values. If a rule matches the incoming request arguments, then a corresponding response is sent back by the web service to the requesting service or application. If no rule matches the incoming arguments, then the default rule can be executed and the default response data will be returned.

An emulation rule can be created for every test case for which the web developer wants to send back values. For example, if the arguments are two integers and operand, and it is known that several range values will be tested against the incomplete web service in the web server, then a rule can be provided for each case. One group of arguments may be the integer ‘100’, ‘0’, and the square root operand ‘sqrt’. Accordingly, the user would enter the return value of ‘10’. This means that the value of 10 would be sent back every time the matching arguments are received even though no actual computation is taking place.

The emulation rules can also be set to ignore or exclude certain arguments. In other words, the arguments that trigger a response can be designated. For example, a rule can be set so if a first multiplication argument is 0 then the other arguments can be ignored and a 0 can be returned.

In a sense, the emulation rules in the web services are reflecting the data programmed by an end user or software developer. Since these rules are dynamically programmable, this allows the developer to customize the rule to specific testing needs at anytime. These rules are also created by the end user after the service is instantiated and running on the web server.

In another embodiment, the request rules and response rules can be loaded from data stored in recorded communications between an actual web service and requesting services, as recorded by the web service logs. This way the emulation rules can emulate actual traffic which has previously been stored in XML or other types of formatted files.

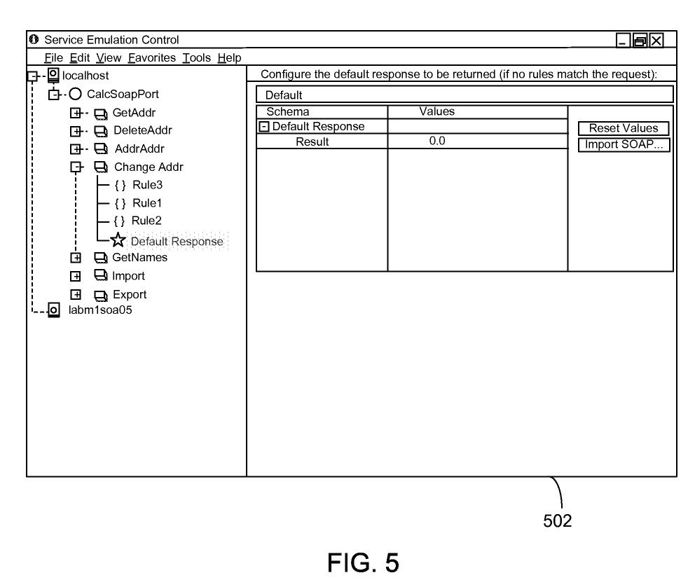

FIG. 5 illustrates a user interface 502 displaying the details of an emulation rule that is a default response rule. This is a default rule that can be executed when request arguments are received but there is no rule that matches the incoming arguments. As a result, a default rule only has response values that are created by the end user and does not have request values. Having a default rule also means a web service that receives a request during testing will not return garbage data or random data, even if a matching rule has not been created by the end user.

Another type of rule that can be included in the group of emulation rules is exception fault rules. These rules can be used to emulate certain types of faults or other errors. For example, a missing mandatory element may be identified or the businesses data may not be valid. This might occur if an integer argument was expected and a string was received or if an expected customer ID was not received. In such cases, an error can be generated by the exception fault rule and the appropriate error can be returned. In another example, a computation service may return an “out of bounds” error if a divide by zero is attempted.

The emulation rules can also include rules that are configured to check for defined expression syntax in request arguments. The syntax rule may parse the incoming request arguments to find the desired defined expressions. In another embodiment, similar rules may be included that check for regular expression syntax in the request arguments. Other language oriented rules can also be used to check the incoming web service requests.

In the testing tools and the development environment provided to the end user or software developer, an original web service address may be overridden by an address of the web service containing emulated rules. Then when the testing is completed and message routing to the completed web service is desired, the address override can be turned off. This address override can alternatively be located in the client application or with the application orchestration module. In another embodiment, the address override functionality can be located on the test server containing the web service when the web server is running on the same local machine as the application being developed.

In emulating the functionality that is expected to be eventually provided by the web service, some time delay may need to be added by the emulation rules to emulate the processing time that will be consumed when the web service functionality is completed at a later point in time. The emulation rules can include a time delay to emulate a service's expected processing period. This time delay can be added to the rule through the user interface. Including time delays helps testers to gauge the overall execution speed of the application even before all the service components are completed.

The described system and method helps increase the development speed of web applications in SOA environments because software developers are able test a web service under development against web services that have not yet been implemented. This avoids the bottlenecks that can be created while developers are waiting for integrally dependent web services to be developed.

Since nearly all web services depend on other web services, waiting for other web services to be developed can slow down an entire application development process. In SOA and integration environments, the services and systems are loosely coupled yet consist of hundred of components and particles. In such situations, dependencies grow exponentially and services which depend on each other can easily break or have development delayed. This delay effect can be multiplied by other integration mechanisms such as BPEL, portals, or similar systems. Avoiding delays in development and testing using the present system and method helps to save companies money and decrease application time-to-market.

Another result of the present system and method is that the testing of web services can be accelerated. Even where some of the web services in the total process have not been completed or implemented yet, emulating the functionality of these services allows software developers and testers to complete the testing cycle for current development modules much earlier.

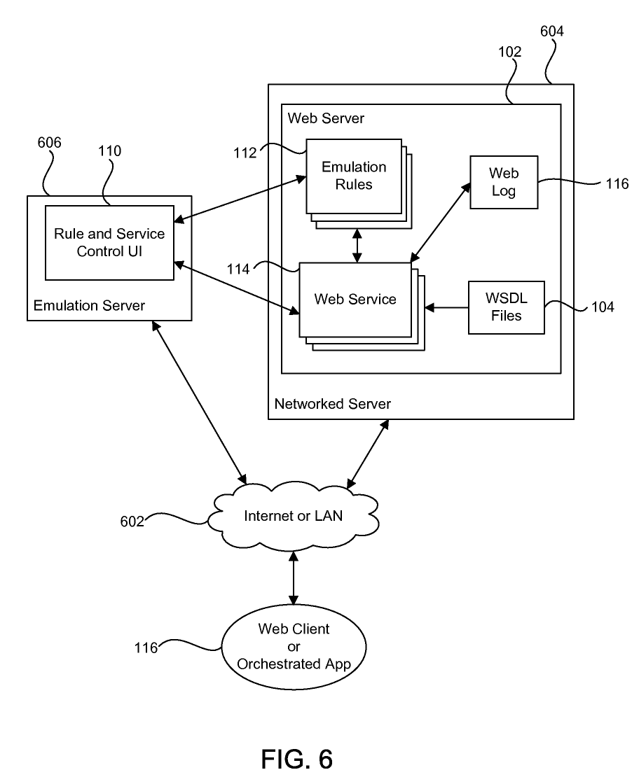

The web server and web service can also be in communication across a network. FIG. 6 illustrates that the networked web server 604 and web service 114 can be accessed by the web client or orchestrated application 116 over the Internet or a local area network (LAN) 602. In this configuration, many clients can access the web service with its emulated rules and test cases. FIG. 6 further illustrates that the user interface 110 used to create rules and update the rule responses can also be hosted on a separate emulation server 606 that is accessible to the end user over the network through a web browser.

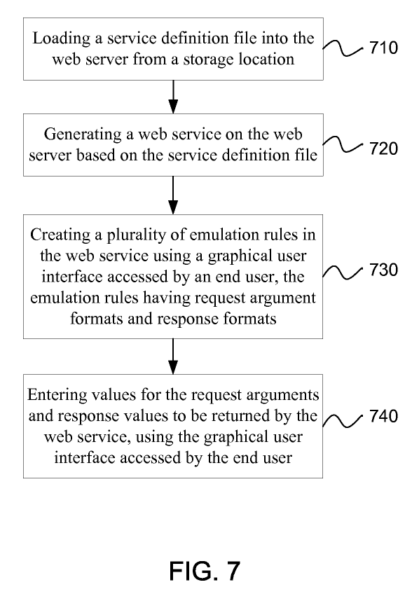

FIG. 7 illustrates an embodiment of a method of emulating the functionality of a web service hosted by a web server. The method can include the operation of loading a service definition file into the web server from a storage location, as in block 710. The service definition file can be used to generate and start a web service in the web server, as in block 720. The web server may be a local web server or the web server may be located on an accessible network. The web service can be available to other services using the web service's previously contracted interfaces that are defined in the service definition files or WSDL. In other words, specific call parameters or request arguments and their data formats (e.g., string, integer, Boolean, etc.) are defined by the WSDL. In addition, return value formats or response formats are also pre-defined and published for the web service.

A plurality of emulation rules can also be created in the deployed web service using a graphical user interface accessed by an end user, as in block 730. The emulation rules can have request argument formats and response formats as defined by the service definition files.

The request arguments and response formats can be viewed by an end user through a graphical user interface. A form that contains user entry controls may be used to enable the entry of actual values for the request arguments and responses. Test case values can be entered by the end user for the request arguments and response values via the user interface, as in block 740.

Once the web service has been setup, then a web client or requesting web service can access the web service with the emulated rules by using request arguments. The requesting web service knows the address of the web service and the defined interfaces of the web service with its emulation rules. The web service's interfaces are defined by a WSDL and both the web client and the web service have the same definition so that the web service can interact with the web client.

Any incoming request arguments can be checked against the user defined request argument values. When matching request arguments are received, the response values can be returned by the web service. The test case values can be entered using the formats and entry controls presented by the graphical user interface accessed by the end user. For example, text boxes, pick lists, drop down data lists, radio buttons (for true/false values), and other user entry controls can be used.

As discussed previously, the emulation rules can each have a separate priority value and default response rules can be invoked when other emulation rules are not applicable. Other types of rules can be created such as exception fault rules that are invoked when error data occurs or other types of business checking rules can be created.

Another use for the present system and method is in performance analysis. Functionality emulated in web services can be used as a tool to analyze where bottlenecks in the requesting services exist. When a service is being emulated, the end user can set an emulated service's response time and use that to identify suspicious bottle necks.

In a similar manner, debugging can occur using the emulated rules. The emulation rules can return data to the requesting services in way that the data can act as a breakpoint or checkpoint. Alternatively, the user created data returned by the web service can also help developers debug problems with data processing.

Emulated rules in a web service can also be used in request testing. In an SOA architecture, sometimes it is desirable to not only test the response of a service but to actually test the incoming request traffic. This type of testing can be used to test applications and clients. For example, the web service can be configured with emulation rules to test the incoming request data and return or log responses identifying whether the correct information is in the request or not. In addition, it can be valuable to test integration logic that is used for the actual business logic and this may be best tested using white box logic as a result of inspecting request messages that are received by the emulated rules. To reiterate, the values that are received can be validated to make sure the requesting web service is sending the appropriate messages.

Another way in which the rule emulation in a web service can be used is in the installation, deployment and staging of applications. Using service emulation in a staging effort is more easily achieved while undergoing small steps to eliminate non-recoverable staging actions. This allows developers to incrementally deploy new services into an environment after the deployed service has been tested against the emulated functionality.

To reiterate, emulating rules for web services can help to create test cases before the development of the web service and other components of the application are completed. Developing test cases and test scripts in parallel with the web service development accelerates the time to market because once the web service is completed then the test cases and scripts that were completed using the emulated rules can be applied to the web service during the final testing phases.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for emulating functionality of a web service, comprising:
a web server configured to host web services;
a web service configured to execute on the web server as defined by a service definition file;
a plurality of executable emulation rules in the web service, the emulation rules having request argument formats and response formats;
a graphical user interface configured to enable an end user to enter values for expected request arguments and response values to be returned by the web service for each executable emulation rule when the expected request arguments are received.

2. A system as in claim 1, wherein the service definition file is configured to define the web service, the request arguments formats, and response argument formats and wherein the service definition file is loadable by the web server.

3. A system as in claim 1, wherein a priority value can be applied to the plurality of executable emulation rules wherein higher priority rules have precedence over lower priority rules in a conflict.

4. A system as in claim 1, wherein the plurality of executable emulation rules include default response rules.

5. A system as in claim 1, wherein the plurality of executable emulation rules include exception fault rules.

6. A system as in claim 1, wherein the plurality of executable emulation rules include syntax rules to check defined expression syntax in request arguments.

7. A system as in claim 1, wherein the plurality of executable emulation rules include language rules to check for regular expression syntax in request arguments.

8. A system as in claim 1, wherein the plurality of emulation rules include a time delay to emulate an expected service's processing period.

9. A system as in claim 1, wherein an original web service address can be overridden by a web service web address of the web service containing executable emulation rules in a development environment.

10. A system as in claim 1, wherein the service definition file is a WSDL file.

11. A method of emulating functionality of a web service hosted by a web server, comprising the steps of:
loading a service definition file into the web server from a storage location;
generating a web service on the web server based on the service definition file;
creating a plurality of emulation rules in the web service using a graphical user interface accessible to an end user, the emulation rules having request argument formats and response formats; and
entering values for the request arguments and response values to be returned by the web service, the values being entered using formats presented by the graphical user interface accessible by the end user.

12. A method as in claim 11, further comprising the step of enabling a client or requesting web service to access the web service using request arguments.

13. A method as in claim 11, further comprising the step of applying a priority value to each of the plurality of emulation rules wherein a higher priority rule has precedence over a lower priority rule in a conflict.

14. A method as in claim 11, further comprising the step of including default response rules with the plurality of emulation rules, the default response rules being invoked when other emulation rules are not applicable.

15. A method as in claim 11, further comprising the step of including exception fault rules with the plurality of emulation rules, the exception fault rules being invoked when an error occurs.

16. A method as in claim 11, further comprising the step of including syntax checking rules with the plurality of emulation rules, the syntax checking rules being configured to check defined expression syntax in request arguments.

17. A method as in claim 11, further comprising the step of including syntax checking rules that check for regular expression syntax in request arguments and are used with the plurality of emulation rules.

18. A method as in claim 11, further comprising the step of including a time delay for any of the plurality of the emulation rules to emulate a services' processing period.

19. A method as in claim 11, further comprising the step of overriding an original service web address with an emulated rule service web address in a development environment.

20. A method as in claim 11, wherein the step of entering values for the request arguments and response values further comprises the step of entering test case values for the request arguments and response values to be returned by the web service, the values being entered using formats presented by the graphical user interface viewable to the end user.

21. A system for emulating functionality of a web service, comprising:
a web server configured to host web services;
a service definition file configured to define a web service and the service definition file is loadable by the web server;
a web service executing on the web server as defined by the service definition file;
a plurality of executable emulation rule means in the web service having request argument formats and response formats, the emulation rule means being for receiving request arguments and return responses;
a graphical user interface means for enabling an end user to enter values for expected request arguments and response values to be returned by the web service for each executable emulation rule means when the expected request arguments are received from another executable process.

22. A system as in claim 21, wherein the plurality of executable emulation rule means include default response rule means.

23. An article of manufacture including a computer usable medium having computer readable program code embodied therein for emulating functionality of a web service hosted by a web server, comprising computer readable program code capable of performing the operations of:
loading a service definition file into the web server from a storage location;
generating a web service on the web server based on the service definition file;
creating a plurality of emulation rules in the web service using a graphical user interface configured to be viewable to an end user, the emulation rules having request argument formats and response formats; and
entering test case values for the request arguments and response values to be returned by the web service, the test case values being entered using formats presented by the graphical user interface configured to be viewable to the end user.

24. An article of manufacture as in claim 23, further comprising the operation of applying a priority value to the plurality of emulation rules wherein a higher priority rule has precedence over a lower priority rule in a conflict.
